(19) United States
(12) Patent Application Publication
(10) Pub. No.: US 2020/0312145 A1
(43) Pub. Date: Oct. 1, 2020

(54) TWO-WAY PERSONALIZED COMMUNICATIONS FOR INDIVIDUALS WITH IMPAIRMENT

(71) Applicant: International Business Machines Corporation, Armonk, NY (US)

(72) Inventor: Gregory R. Hintermeister, Rochester, MN (US)

(21) Appl. No.: 16/364,368

(22) Filed: Mar. 26, 2019

(51) Int. Cl. G08G 1/0968; G09B 21/00; G07C 5/00

(52) U.S. Cl. CPC G08G 1/096855; G07C 5/008; G09B 21/009

(57) ABSTRACT

A method for operating a vehicle system component may utilize a processor to receive initial information related to a user of a vehicle, and send, to a user device having a unique identifier, an invitation to connect to the vehicle system component to establish a private two-way communication channel for a personal conversation between the user device and a bot associated with the vehicle. The processor may receive an acceptance of the invitation, responsive to receipt of the acceptance, create the bot, and establish a private two-way communication channel between the user device and the bot. The processor may then send, from the bot to the user, information that is responsive to received user information over the private two-way communication channel. The processor may terminate the bot and the private two-way communication channel according to a termination criterion.

### BACKGROUND

Disclosed herein is a system and related method for providing two-way personalized communications for individuals with an impairment to communicate with a public transit system or associated vehicle.

Public transportation may be difficult enough when individuals in good health use public transportation systems. However, individuals with an impairment may encounter significant additional difficulties when trying to use these systems. Depending on the extent of impairment, it may be too difficult in some circumstances for a person with an impairment to use public transportation without additional assistance.

### SUMMARY

According to one aspect disclosed herein, a computer-implemented method for communications may be provided. The method may comprise receiving, by a vehicle system component, initial information related to a user of a vehicle. The method may send, by the vehicle system component to a user device having a unique identifier, an invitation to connect to the vehicle system component to establish a private two-way communication channel for communication between the user device and a bot associated with the vehicle during a trip. The invitation comprises information related to the initial information. The method further comprises receiving an acceptance of the invitation, and, responsive to receipt of the acceptance, creating the bot and establishing the private two-way communication channel between the user device and the bot. The method further comprises sending, from the bot to the user, information responsive to received user information over the private two-way communication channel that incorporates the initial information. The bot and the private two-way communication channel may be terminated according to a termination criterion.

According to another aspect disclosed herein, a system for a vehicle system component may be provided comprising a processor that is configured to perform various operations. The processor may receive initial information related to a user of a vehicle, and send, to a user device having a unique identifier, an invitation to connect to the vehicle system component to establish a private two-way communication channel for a personal conversation between the user device and a bot associated with the vehicle during a trip. The invitation comprises information related to the initial information. The processor may receive an acceptance of the invitation, responsive to receipt of the acceptance, create the bot, and establish a private two-way communication channel between the user device and the bot. The processor may then send, from the bot to the user, information that is both responsive to received user information over the private two-way communication channel that incorporates the initial information. The processor may then terminate the bot and the private two-way communication channel according to a termination criterion.

According to another aspect disclosed herein, a computer program product for a vehicle system component, the computer program product comprising a computer readable storage medium having computer-readable program code embodied therewith to, when executed on a processor, causes the vehicle system component to perform operations described herein.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 depicts a cloud computing environment according to an embodiment of the present invention.

FIG. 2 depicts abstraction model layers according to an embodiment of the present invention.

FIG. 3 is a block diagram of a DPS according to one or more embodiments disclosed herein.

FIG. 4 is a block diagram of one or more embodiments of a vehicle communication system, as disclosed herein.

FIG. 5 is a flowchart illustrating one or more embodiments of a computer-implemented method for communicating between a vehicle and user, as disclosed herein.

### DETAILED DESCRIPTION

An individual with an impairment may find it difficult or impossible to avail themselves of public transportation that might otherwise be available to them without additional assistance. By providing additional assistance to such an individual, however, travel using a public transportation system may become possible or significantly more convenient and less stressful. Such additional assistance may be provided in the form of private two-way communications between the vehicle (or a related vehicle system server) and a user communications device or user aid of the user. These private two-way communications may be used to provide information, make requests, and communicate other relevant information between the user and components of the transportation system. This may be particularly true for breakthrough vehicle technology such as driverless cars and buses because there may not necessarily be a responsible individual present who might otherwise be able to provide assistance to individuals who need it. Although some embodiments described herein are directed to addressing communications with individuals having a disability, and in particular, individuals having a hearing disability, other embodiments may not be so limited, and may be utilized by individuals having no disabilities.

For individuals having a hearing impairment whose user aid is a hearing aid, a group of people may receive audio using their telecoils (t-coils). A t-coil is a small coil of wire inside of a hearing aid that is designed to pick up an electromagnetic signal. When using the telecoil setting on the hearing aid, the microphone is turned off so that the hearing aid will only pick up the electromagnetic signal and convert it to sound. This allows the user to hear only the electromagnetic signal from the sound source which may be from hearing aid compatible phones and a number of Assistive Listening Devices. However, the noise, commotion, and distractions of crowded environments, such as cities, may be too much for a simplistic communication mechanism to maximize the potential of a smart vehicle that may serve the user. Furthermore, the t-coil of a hearing aid can only communicate in one direction and serve as an input to the hearing aid. It does not provide a good way for the person with an impairment to respond. Thus, it is desirable to provide a mechanism for private two-way communications between the person with disabilities and the vehicle (or its respective processor/bot/AI assistant) so that trusted information may be shared, personalized guidance may be provided, and help may be requested or provided to the user.

The following acronyms may be used below:
API application program interface
ARM advanced RISC machine
CD-ROM compact disc ROM
CMS® content management system
CoD capacity on demand
CPU central processing unit
CUoD capacity upgrade on demand
DPS data processing system
DVD digital versatile disk
EPROM erasable programmable read-only memory
FPGA field-programmable gate arrays
HA high availability
IaaS infrastructure as a service
I/O input/output
IPL initial program load
ISP Internet service provider
ISA instruction-set-architecture
LAN local-area network
LPAR logical partition
LTA logging/tracking/audit
PaaS platform as a service
PDA personal digital assistant
PLA programmable logic arrays
RAM random access memory
RISC reduced instruction set computer
ROM read-only memory
SaaS software as a service
SLA service level agreement
SOI search optimization service
SRAM static random access memory
WAN wide-area network

### Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

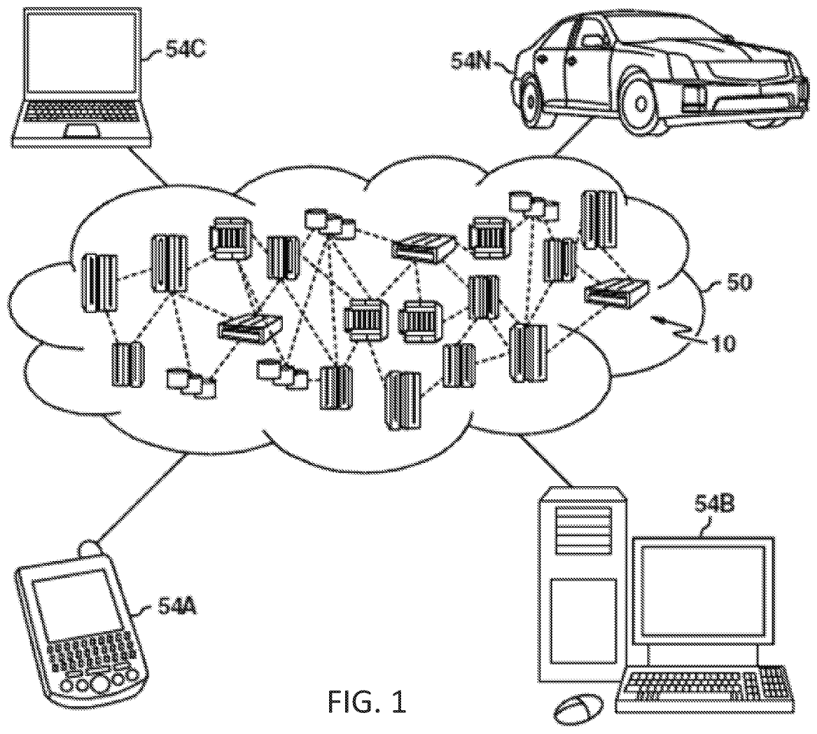

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

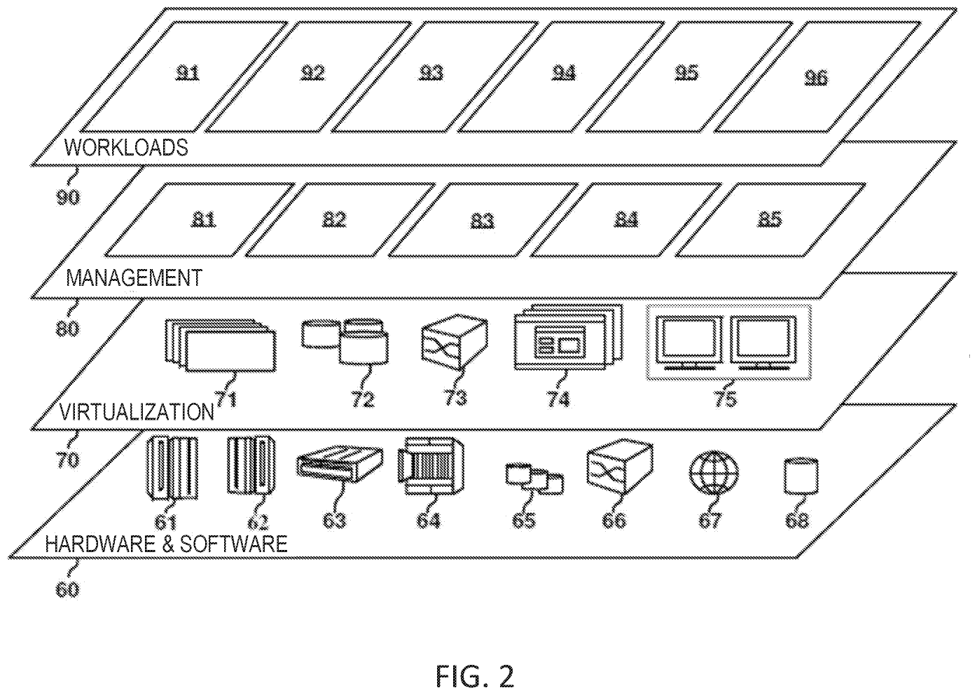

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and vehicle communications 96.

### Data Processing System

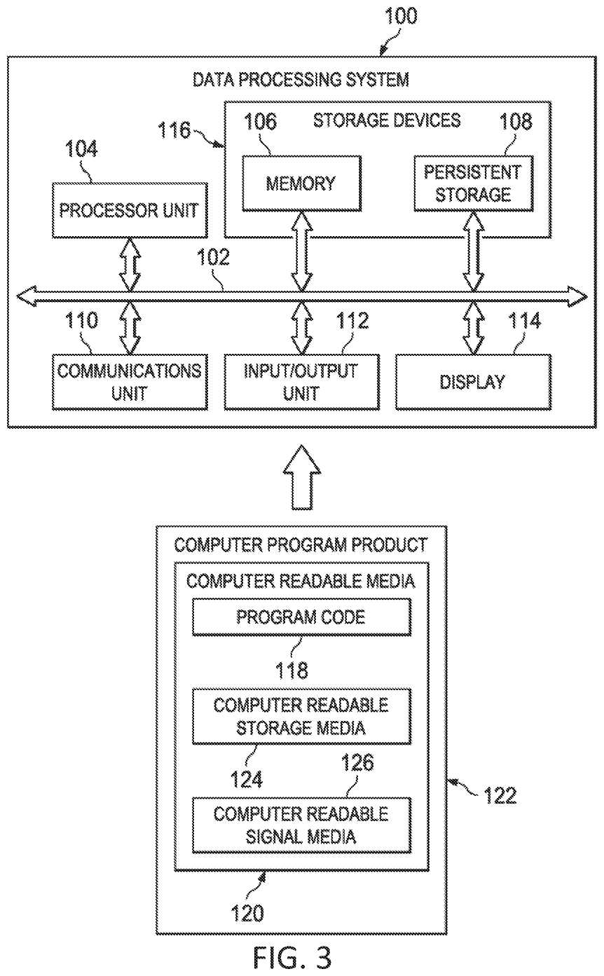

FIG. 3 is a block diagram of an example DPS according to one or more embodiments. The DPS may be used as a cloud computing node 10. In this illustrative example, the DPS 100 may include communications bus 102, which may provide communications between a processor unit 104, a memory 106, persistent storage 108, a communications unit 110, an I/O unit 112, and a display 114.

The processor unit 104 serves to execute instructions for software that may be loaded into the memory 106. The processor unit 104 may be a number of processors, a multi-core processor, or some other type of processor, depending on the particular implementation. A number, as used herein with reference to an item, means one or more items. Further, the processor unit 104 may be implemented using a number of heterogeneous processor systems in which a main processor is present with secondary processors on a single chip. As another illustrative example, the processor unit 104 may be a symmetric multi-processor system containing multiple processors of the same type.

The memory 106 and persistent storage 108 are examples of storage devices 116. A storage device may be any piece of hardware that is capable of storing information, such as, for example without limitation, data, program code in functional form, and/or other suitable information either on a temporary basis and/or a permanent basis. The memory 106, in these examples, may be, for example, a random access memory or any other suitable volatile or non-volatile storage device. The persistent storage 108 may take various forms depending on the particular implementation.

For example, the persistent storage 108 may contain one or more components or devices. For example, the persistent storage 108 may be a hard drive, a flash memory, a rewritable optical disk, a rewritable magnetic tape, or some combination of the above. The media used by the persistent storage 108 also may be removable. For example, a removable hard drive may be used for the persistent storage 108.

The communications unit 110 in these examples may provide for communications with other DPSs or devices. In these examples, the communications unit 110 is a network interface card. The communications unit 110 may provide communications through the use of either or both physical and wireless communications links.

The input/output unit 112 may allow for input and output of data with other devices that may be connected to the DPS 100. For example, the input/output unit 112 may provide a connection for user input through a keyboard, a mouse, and/or some other suitable input device. Further, the input/output unit 112 may send output to a printer. The display 114 may provide a mechanism to display information to a user.

Instructions for the operating system, applications and/or programs may be located in the storage devices 116, which are in communication with the processor unit 104 through the communications bus 102. In these illustrative examples, the instructions are in a functional form on the persistent storage 108. These instructions may be loaded into the memory 106 for execution by the processor unit 104. The processes of the different embodiments may be performed by the processor unit 104 using computer implemented instructions, which may be located in a memory, such as the memory 106.

These instructions are referred to as program code, computer usable program code, or computer readable program code that may be read and executed by a processor in the processor unit 104. The program code in the different embodiments may be embodied on different physical or tangible computer readable media, such as the memory 106 or the persistent storage 108.

The program code 118 may be located in a functional form on the computer readable media 120 that is selectively removable and may be loaded onto or transferred to the DPS 100 for execution by the processor unit 104. The program code 118 and computer readable media 120 may form a computer program product 122 in these examples. In one example, the computer readable media 120 may be computer readable storage media 124 or computer readable signal media 126. Computer readable storage media 124 may include, for example, an optical or magnetic disk that is inserted or placed into a drive or other device that is part of the persistent storage 108 for transfer onto a storage device, such as a hard drive, that is part of the persistent storage 108. The computer readable storage media 124 also may take the form of a persistent storage, such as a hard drive, a thumb drive, or a flash memory, that is connected to the DPS 100. In some instances, the computer readable storage media 124 may not be removable from the DPS 100.

Alternatively, the program code 118 may be transferred to the DPS 100 using the computer readable signal media 126. The computer readable signal media 126 may be, for example, a propagated data signal containing the program code 118. For example, the computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 118 may be downloaded over a network to the persistent storage 108 from another device or DPS through the computer readable signal media 126 for use within the DPS 100. For instance, program code stored in a computer readable storage medium in a server DPS may be downloaded over a network from the server to the DPS 100. The DPS providing the program code 118 may be a server computer, a client computer, or some other device capable of storing and transmitting the program code 118.

The different components illustrated for the DPS 100 are not meant to provide architectural limitations to the manner in which different embodiments may be implemented. The different illustrative embodiments may be implemented in a DPS including components in addition to or in place of those illustrated for the DPS 100. Other components shown in FIG. 1 may be varied from the illustrative examples shown.

### Vehicle Personalized Communications System

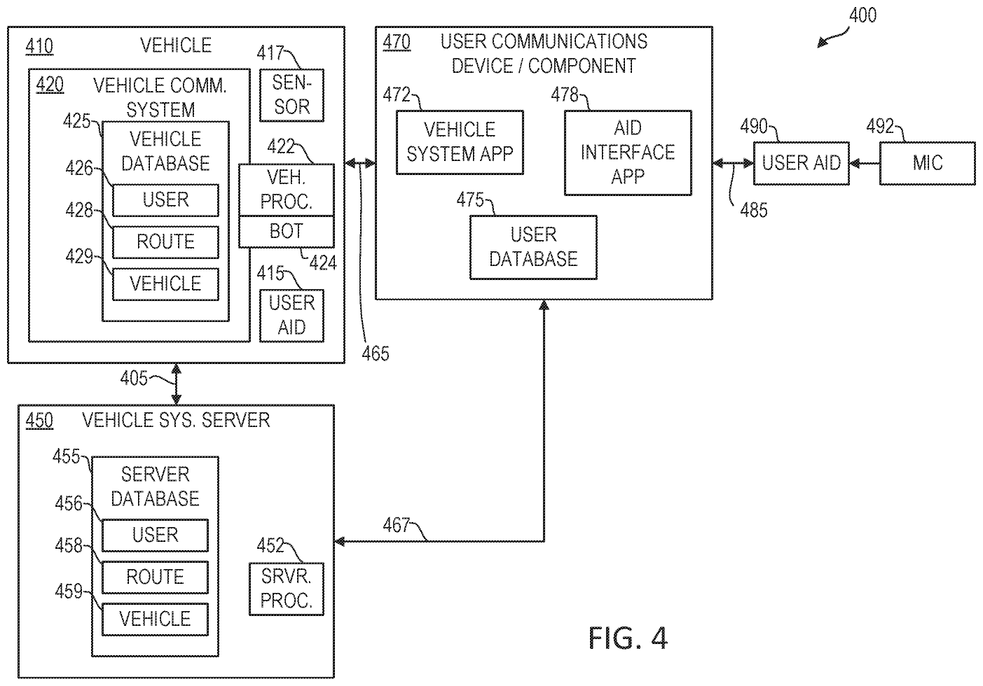

FIG. 4 is a block diagram illustrating an example of a vehicle personalized communications system 400 according to various embodiments disclosed herein. The primary components of the system 400 may include a vehicle 410, such as an automobile, bus, train, boat, or any other machine used to transport passengers, and which may or may not have a driver or pilot. The vehicle 410 may be a standalone vehicle or it may connect to a centralized vehicle server 450 via a system network 405. The vehicle 410 may also be designed to interface via a communication connection or network 465, 485 to a user aid 490 that is used to, e.g., assist a handicapped user using a vehicle communication system 420. In some embodiments, the user aid 490 is a hearing aid, where the user's handicap is a hearing problem. The hearing aid may have a telecoil or other audio transmission technology that is used to generate an audio signal for the user. The vehicle 410 may comprise various user aids 415, such as a ramp, wheelchair lift, and/or hearing aid telecoil communications devices. The vehicle may also comprise sensors 417 that may be utilized to detect various conditions associated with the vehicle (e.g., positions of ramps, lifts, doors, individuals, etc.) or road conditions (e.g., potholes or other bumps, sharp corners, etc.), or weather conditions (icy, wet/rainy) that may impact a user's ability to enter and exit the vehicle. Intelligent decision-making and user communications of the vehicle 410 may be incorporated in a vehicle processor 422 comprising hardware and software that may implement, e.g., various Artificial Intelligence (AI) used by the vehicle 410, such as IBM Watson,® Cortana,® etc. The vehicle processor 422 may be a part of the vehicle communication system 420 or it may be a separate component that interacts with the vehicle communication system.

The user aid 490 may comprise a user communication device 470 that may either be a part of the user aid 490, e.g., an integral part within a common housing, or that may be separate from the user aid 490 but be connected to the user aid via a user aid network 485 or connection that connects the user communications device 470 with the user aid 490. The user communications device 470 may be dedicated to supporting the user aid 490, or may be a general-purpose user communication device, such as a smart phone, that includes an aid interface app 478 that interfaces to the user aid 490. The user aid 490 may also be associated with a microphone 492 that allows the user to communicate with other system components using voice or audio. The user aid 490 may contain a speaker that is capable of producing audio, possibly exclusively, for the user. Thus, the user aid 490 may provide for interactive two-way communications between the user and the vehicle communication system 420.

The user communication device 470 may also comprise a vehicle system app 472 that is used to communicate with one of or both the vehicle 410 (via the vehicle communication system 420) or the centralized vehicle server 450. The vehicle system app 472 may be downloaded to the user communications device 470 from, e.g., the vehicle system server 450 via, e.g., an app store. A user device vehicle network 465 connecting the vehicle communication system 420 and the user communication device 470 may be a same network or same type of network as the system network 405 that connects the user communication device 470 to the centralized vehicle server 450, or it may be a different network or different type of network. Similarly, a user device system network 467 may be the same/same type of network or a different network as the other networks discussed above. A private communication channel set up with the user may be between the user communications device 470 and the vehicle 410 via the user device vehicle network 465, and/or between the user communications device 470 and the vehicle system server 450 via the user device system network 467. It may also be directly between the vehicle communications system 420 and the user aid 490 in a simple implementation. Any reference to use of the private communication channel herein may include any one of the types of connections/networks mentioned above.

In an example use case utilizing some embodiments described herein, a user has a hearing aid as the user aid 490 that interfaces with the user's communications device 470, which may be a smart phone. A hearing aid manufacturer may provide the aid interface app 478 on the user's smart phone, which may be used to control the hearing aid, but also may be used to provide communications to and from the hearing aid. Information about the user may be stored in a user database 475 of the user's smart phone. This information may include information about the user herself (identifying information, address, phone, nature of handicap, etc.) as well as device information, travel information, and any other information. The user's smart phone may also comprise the vehicle system app 472 that may be used to communicate with the vehicle communication system 420 and/or the vehicle system server 450.

In the example use case, the vehicle 410 may be a bus, and the vehicle system app 472 may be used to establish communications between the vehicle 410 and the user's communications device 470 (the smart phone), e.g., before the user with a hearing impairment boards the bus, such as while the user is waiting at a bus stop. Depending on various scenarios described below, a secure communications channel may be established so that the user and the vehicle communications system 420 are able to directly communicate with one another.

A variety of possibilities exist for establishing communications. In some embodiments, the user undergoes a registration process prior to attempting travel. In various embodiments, the user may communicate with the vehicle system server 450 via, e.g., the vehicle system app 472 over the user device system network 467 to provide it with information that may subsequently be accessed by the vehicle 410 via the system network 405. The vehicle system app 472 may be a standalone app, implemented via a browser interface, or take on some other form. The vehicle system app 472 may convey information about the user, the user's devices, situation, travel, etc. that is stored in the user database 475 or entered by the user to the vehicle system server 450, which may store this information in a server database 455. In one example, the server database 455 may comprise a user portion 456 containing information about users of the system. The server database 455 may also comprise a route portion 458 that stores, e.g., map information, including real-time information such as traffic, road conditions, distances, directions, and even weather of station status information at stations or stops associated with the vehicle 410. The server database 455 may also comprise a vehicle portion 459 that contains information about vehicles used by the system such as type (train, bus, automobile, etc.), capabilities to assist handicapped users (e.g., ramp, wheelchair lift, telecoils, etc.) and other vehicle-related information.

If the user registers with the vehicle server 450, the server 450 may store the user information in the user portion 456 in a record that uniquely defines the user (e.g., by a unique user ID or device ID (smartphone phone number, MAC address, etc.)). By storing this user information ahead of time, the server 450 may have relevant information (e.g., type of assistance preferred by the user or other preferences that make the user's experience more pleasant) handy without requiring the user to constantly enter this information. Such a pre-travel registration process may permit the user to use a more convenient information entry system, such as a personal computer, that may not be present when the user has set out on a trip. The route portion 458 may be populated, e.g., by access to commercially available map and route databases. Similarly, the vehicle portion 459 may be populated by a registration app (not shown) that allows vehicles to register and change their information on the server 450. The intelligence of the vehicle system server 450 may be provided by a server processor 452 that may utilize hardware and software to execute various functions of the vehicle system server 450 and may incorporate features such as AI.

A trip may be defined in terms of various stages. There may be a pre-trip stage that occurs prior to any change in location related to the trip—this may be thought of as a planning stage or the like. There may be an initial stage of the trip that defines a starting segment of the trip. The initial stage may be waiting at a bus stop, or even getting from a user's home to the bus stop. There may be a vehicle boarding stage during which the user may enter the vehicle. For certain impairments, the vehicle boarding stage may involve user assistance, such as utilization of a wheelchair ramp or the like. There may be a vehicle travel stage during which the user may be seated or in a traveling position while the vehicle is in motion. There may be a vehicle exiting stage that, similar to the vehicle boarding stage, may involve user assistance. There may be a final stage after the user has exited the vehicle, such as a user's walk from a bus stop to a building. Additional stages may be contained within or associated with the trip as well.

In an implementation, user registration may occur at a preliminary portion of the trip itself, as opposed to a pre-trip period of time, as discussed above. For example, in the use case described above, user registration may take place while the user is waiting at a bus stop. In this implementation, the vehicle system app 472 may collect user information from the user and/or the user database 475 in a manner similar to the registration process described above. The collection of the user information may be based on a number of different triggers. For one trigger, the vehicle system app 472 may have information of the user's trip based on, e.g., an indication by the user or possibly by accessing the user's Global Positioning System (GPS) information and determining that the user is at a valid location, e.g., particular stop associated with the vehicle 410, such as a bus stop. Thus, when the vehicle system app 472 detects the user being in a valid location, it may prompt the user to enter the user registration information, or, when the user information is already present in the user database 475 and the user has authorized this data to be accessible by the vehicle 410 and/or the vehicle system server 450, the data may automatically be transferred from the user communications device 470 over the user device vehicle network 465 or the user device system network 467.

In other embodiments, for another trigger, the vehicle communication system 420 may broadcast or multicast an imminent approach or an arrival time of the vehicle 410 to a particular location or stop, and this broadcast may be received by any user communications devices 470 that are located in a designated area. The broadcast/multicast may contain various information contained in, e.g., a route portion 428 and/or a vehicle portion 429 of a vehicle database 425.

The broadcast/multicast may also contain information such as an invitation indicating that the user communications device 470 may directly connect to the vehicle communication system 420 so that e.g., a secure communications channel may be established between the vehicle 410 and the user communications device 470 and/or the user aid 490. In various embodiments, the vehicle communications system may be able to communicate directly to the telecoil of the user aid 490. In response to this invitation, the user may accept the invitation in order to establish a secure communications channel between the vehicle 410 and the user aid 490. In some embodiments, the invitation by the vehicle 410 may be configured to be automatically accepted, in which case the user does not need to take additional actions in order to establish the private communication channel. In some embodiments, a telecoil system may have multiple channels. In a multi-channel system, different channels may have different functions. For example, a default channel (e.g., channel one) may announce the invitation, channel two may be used for the hearing impaired, channel three for the sight impaired, channel four for the mobility impaired, etc. In some implementations, a channel could be directly, but temporarily, assigned to a particular user for the duration of the trip. The number of channels could be expanded to encompass an expected maximum number of users for a given trip.

The user information may be collected directly by the vehicle server 450 or via communications with the vehicle communication system 420. When collected by the vehicle communication system 420, this information may be stored in a vehicle database 425, which may reside on the vehicle and which may contain the user portion 426, the route portion 428, and the vehicle portion 429, which may be similar in structure and content as the server database 455 on the vehicle system server 450, although the vehicle database 425 does not necessarily need to contain information on all routes or vehicles in the system—only those applicable to that particular vehicle. The route portion 428 may persistently store information about various routes the vehicle 410 may travel over—such information may be acquired from any map or direction database. The vehicle portion 429 may persistently store information about the vehicle and may be identified by a unique identifier such as a vehicle identification number (VIN). Such information may include any information related to the vehicle, and in particular may contain information related to types of user aids 415 that may be used to assist the user, such as ramps and lifts, hearing aid telecoil communications capabilities, and/or various software components of the vehicle 410 that may permit the user to, e.g., contact others for needed assistance. In various embodiments, the vehicle 410 or server 450 may receive an assistance request from the user. Such a request may be a request to have someone help the user get down the vehicle steps when they exit. A message may be sent out to other riders on the vehicle or possibly to others who have registered to provide assistance of the type requested by the user, possibly in a manner similar to the way ride share services operate. Any responses (or perhaps some subset of responses meeting a particular criterion, such as a first response) may be passed on to the user making the request.

The vehicle database 425 may synchronize relevant portions with the server database 455—in this way, other vehicles that are a part of the vehicle personalized communications system 400 and have access to the vehicle system server 450 may have access to the user information. However, if a user is sensitive about having their information persisted to the vehicle system server 450, in some embodiments, the information may be retained just in the vehicle database 425. The information in the vehicle database 425 may persist for some pre-designated amount of time, including forever, or it may be deleted once a trip is over. A synchronization between the user database 475 and the user portion 426 of the vehicle database 425 may enable the user information to be easily utilized for a trip without it being retained in the vehicle 410 or vehicle system server 450 after the trip is complete.

This initial preliminary part of the trip triggering may be construed as an invitation by the vehicle 410 to establish a secure communications channel with the user communications device 470 or user aid 490 over which private, personalized conversation may occur with the vehicle 410 (or the vehicle system server 450, or other users or travelers) during the course (life cycle: preliminary, during, and post portions) of the trip. The invitation may be received by the user as an audio message, as a text message, chat request, or any other form of communication. Responsive to the user receiving the invitation, the user may “accept” the invitation to establish a private communication channel from the vehicle 410, at which time an exchange of the user information may take place (although some or all of the user information exchange may take place prior to this, depending on the conditions, user authorization, availability of the information, and other factors). In any case, a communication channel may be established once the vehicle 410 has the unique identifier for the user communications device 470 and/or the user aid 490.

According to various embodiments, the vehicle 410 may start an active personal conversation using the position and unique identifier of the user communications device 470 or user aid 490 to establish an active private connection that permits a private conversation between the vehicle 410 and the user. Other users having an impairment may have their own private conversations via their own channels which they may have established in any manner described herein. In embodiments where a sophisticated communications device 470 is not used, a telecoil server may be utilized to generate custom private channels for the user that only an individual's own user aid 490 can hear. Such private channels may be created by having separate magnetic communication devices located proximate seats in the vehicle so that these separate magnetic communication devices are only able to interact with a user in a specific seat of the vehicle 410.

In some embodiments, responsive to the user accepting the communication request and the establishment of a private communication channel, the vehicle processor 422 may create a conversation bot 424 instance to communicate with the user. The bot 424 may utilize the vehicle processor 422 to execute software that, for example, interacts with the user, and may perform the functions discussed herein. When optional personal information is provided (e.g., “I have a visual impairment”, “I need instructions boarding and navigating”, “I have a physical impairment and need a ramp”, etc.) the personal conversation may be responsive to that information. For example, the bot 424 may respond by saying things like, “Hello, Greg. To help with your wheel chair access, navigate 15 feet to your left and wait for the ramp to deploy”, or “Watch out for the dip in the sidewalk 5 feet to your left . . . others have had problems with that”.

The bot 424 may be utilized to bundle together a series of activities and data that are associated with a trip. For example, a trip to a museum may comprise a number of different activities that may need to be coordinated in order for the handicapped user to successfully arrive at his destination, including getting to a vehicle stop, assistance with baggage, wheelchair, etc., and directions upon exiting the vehicle to arrive at the ultimate destination, as well as keeping the user informed throughout the trip, e.g., confirming wheelchair access at a particular vehicle stop. Furthermore, the bot 424 and associated functionality described herein may be located in the vehicle system server 450, or its functionality may be split across the vehicle system server 450 and the vehicle 410. The bot 424 may employ various AI techniques so that it is able to learn, when permitted by the user, about ways to better communicate with the user about the trip. For example, if a particular vehicle stop is frequently a location where inconveniencing repairs are performed, the bot 424 may learn over time of more practical vehicle stops for the user to use. This is particularly so when the information from a plurality of users, vehicles, and other sensors and information sources are combined. When the AI is employed in the server processor 452, similar communications may be provided to groups of similarly situated users (users with similar handicaps, located in a common location, taking a particular route, etc.). The bot 424 may be implemented as software, e.g., provided as a service in a cloud environment. As used herein, the term “bot” is defined broadly to include software or hardware capable of performing any of the functionality defined herein.

The user may respond with various phrases using voice/audio using, e.g., their microphone 492 or their user communications device 470, and the personalized conversation may continue. Data, including audio-based data to and from the vehicle 410 may be encrypted so that the exchange of data and communications may be as private and secure as possible. Any or all of the information described herein may be encrypted prior to transmission or storage. As noted above, some or all of the information from the establishment of the secure communication channel as well as that contained within it may be deleted immediately upon completion of the conversation or the trip, or it may be persisted according to predefined rules (e.g., the conversation data contained within the secure communications channel may be deleted after a week, whereas data associated with the user's ID and situation may persist indefinitely).

The vehicle processor 422 may also integrate various social media-like functions that allow the user to locate others to communicate with or render assistance. In some embodiments, the vehicle processor 422 and/or the bot 424 may be used by the user to solicit needed help. The user may communicate an assistance request to the vehicle 410, e.g., “Vehicle, can you ask around for someone to help me lift my luggage into the vehicle?” or “Can someone give me a hand getting up the stairs?” In response, the vehicle 410 may communicate this request to others in the vicinity who may be able to assist (either free or possibly for a charge). For example, the vehicle 410 may communicate the assistance request first to other nearby users having private conversations with the vehicle 410 in their respective private communications channel, and, absent any takers, may then resort to broadcasting the request, e.g., over a general speaker. This way, if the assistance request is accepted in a private conversation, a user with an impairment may not be made to feel foolish by being called out publicly because only a few select others knew of the request for help. In one implementation, users of the system 400 may indicate their ability and willingness to respond to various requests (again, for free or as a charged service) that are registered in the user portion 426 of the vehicle database 425.

In some implementations, such users who act as responders to these types of requests could extend beyond those using the vehicle 410 itself. For example, if a user needed a taxi ride or a wheelchair push to a location inaccessible to the vehicle 410, such assistance may be coordinated by the vehicle processor 422 and/or by the server processor 452 as well. Various functions described above with respect to the vehicle processor 422 and/or the vehicle communication system 420 may also be performed by the server processor 452 and the vehicle system server 450, and vice versa.

Once the user is on board, she may communicate with the bot 424 regarding aspects of the trip, such as instructions, useful information at various destinations, etc. For example, the user may communicate, “I need to get off at the Museum stop”. Then the bot 424 may then automatically remind the user once the vehicle 410 is approaching the requested stop, prepare any special equipment needed so the user may exit gracefully, and/or request help to get luggage off, if desired.

During the trip, the bot 424 may archive information provided by the user, if the user has given permission for it to do so. This permission may apply to the user herself or to others using the system 400. In the latter case, the user may wish for the information provided to be anonymized. By way of example, during the trip, the user adds the commentary “wow that was a big bump for my wheel chair”, or “I bumped my head when boarding . . . ”. The bot 424 may translate these comments into meaningful and/or standardized information that may be saved within a memory of the vehicle 410 or the vehicle system server 450. Such information may be classified based on various attributes. For example, the big bump information may be classified according to a GPS location, whereas the boarding information may be classified according to a feature of the vehicle. Other attributes may be applied as well.

The bot 424 may operate intelligently to make various inferences. For example, the bot 424 may record the big bump as a disturbance at a GPS location. The next time the user is on board and nearing this location, it may recognize that a person in a wheelchair may wish to lock its wheels in order to minimize undesired movement during the disturbance, stating, e.g., “don't forget to lock your wheels because Fifth Street has a bump”. The person using a walker may get a similar instruction to “hang on as we go over this bump”. Such information may be shared with other users, and similar instructions given with those similarly situated.

Once the conversation is over (e.g., based on a user indication of completeness or by the vehicle communication system 420), the user may choose to “save” custom data or information related to the trip (either previously known data or data acquired during the trip from the user, the vehicle 410, or the vehicle system server 450) to the user communications device 470. In response, the bot 424 (or other entity, such as a part of the vehicle 410 or the vehicle system server 450) may download a custom file onto the user communications device 470 or user aid 490 so that the next time the user interacts with the vehicle 410 or vehicle system server 450, this “past experience” custom data or custom information may be part of the personal information passed to the vehicle 410 or the vehicle system server 450, which may result in the system 400 providing a better custom experience. The user may be incentivized to allow the sharing of some of their information, possibly in an anonymized manner, by making the data of other users available to them on the condition that they've shared their own data.

On exit or termination of the user's trip, the bot 424 may download an “offline” directions guide into the user communications device 470 or user aid 490 to help the person with an impairment leave the area. For example, when the vehicle 410 is a subway train, the bot 424 may communicate custom instructions for “Greg, wheelchair bound user” custom guidance with proximity of his current position to, e.g., get him from the location where he got off the subway train to the nearest elevator, to street level, and possibly to his ultimate destination (e.g., a museum).

In some embodiments, at least one of the vehicle communication system 420, the vehicle system server 450, and the user communication device 470 may be, for example, a DPS 100 and incorporate the elements and features described herein. The software components for any of these may be provided in a computer program product 122 described herein, and the networks provided for interconnecting various components, such as the vehicle communication system 420, the vehicle system server 450, and the user communication device 470 may make use of any of the networking components, protocols, and architectures discussed herein. The vehicle system server 450 may be implemented in a cloud computing environment 50, as described herein, and the system may be implemented as a set of functional abstraction layers as illustrated in FIG. 2.

Similarly, in some embodiments, the networks, such as the system network 405, the user device vehicle network 465, the user device system network 467, and the user aid network 485, may be any format of a network as discussed above with respect to FIG. 1. Such a network may implement various environment-appropriate network protocol and schemes, such as WiFi, Bluetooth, any of the relevant IEEE 802 or ITU standard networks. The user aid network 485 may be a wireless or wired network. The system network 405, the user device vehicle network 465, and the user device system network 467 are preferably wireless networks, but may be, e.g., temporarily, a wired network when various entities are co-located or located proximate to a network interface.

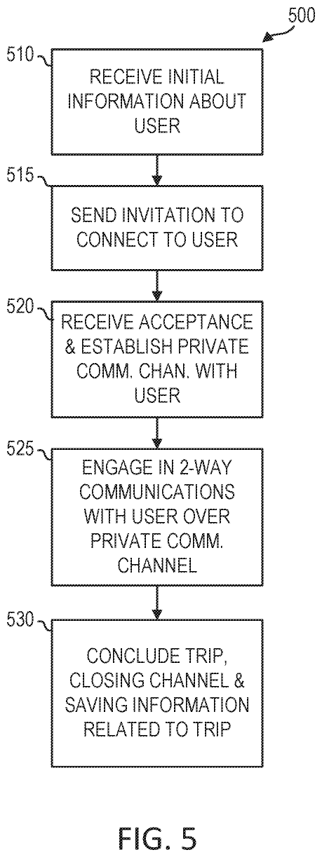

FIG. 5 is a flowchart illustrating an example process 500 according to various embodiments. In operation 510, vehicle 410 or server 450 may receive initial information, e.g., registration information about the user, their devices, the user's trip, or other relevant registration data that may be usable by the vehicle 410 for a trip. The user may provide an indication if they desire to share their registration information with others, possibly in an anonymized manner, and/or have it persistently stored for the sake of convenience. “Persistently stored” (and persistent storage) may be construed herein as storage that at least persists outside of the duration of a trip. The user may use their user communications device 470 (of their user aid 490, if it has the capability to do so) and the system 400 may store their registration information in at least one of the user database 475 on the user communications device 470, the user portion 426 of the vehicle database 425, or the user portion 456 of the server database 455, according to, for example, a user specification. This may occur well in advance of a planned trip during a pre-trip phase or during an initial portion or phase of the trip itself, such as when the user is present at a vehicle stop.

In operation 515, vehicle 410 or server 450 may send the user an invitation to connect with the vehicle 410 (as described and used herein, any operations related to communications with the vehicle 410 may imply communications with the vehicle communication system 420 and alternately or additionally include communications with the vehicle system server 450, depending on the network, user permissions, and the like. A vehicle system component may comprise any or all of the vehicle 410, communication system 420, server 450, and/or components thereof). The invitation to connect may be in the form of a broadcast or multicast or it could be directed to the user in some specific or directed manner. This invitation may be a communication directed to the user communications device 470 or directly to the user aid 490.

In operation 520, the vehicle 410 may receive an acceptance of the invitation, and the vehicle 410 may connect with the user communications device 470 or directly to the user aid 490 using a secure private communications channel that allows the user to communicate in private with the vehicle 410.

Once the secure private communications channel is set up, in operation 525, the user and the vehicle communications system 420 may engage in private two-way communications with one another over the private communications channel. A bot 424 may be created that utilizes the vehicle processor 422 in order to intelligently communicate with the user, as described above. In operation 530, at the conclusion of the trip, the communications channel may be shut down and data obtained on this trip may be deleted or it may be saved in at least one of the user aid 490, the user communications device 470, the vehicle 410, and the vehicle system server 450. The conclusion of the trip may be based on a pre-defined criterion, for example, receipt from a user indicating the trip has concluded, the user arriving at a pre-defined or trip termination location, or completion of executing a pre-defined sequence of trip elements.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for communication comprising:
receiving, by a vehicle system component, initial information related to a user of a vehicle;
sending, by the vehicle system component to a user device having a unique identifier, an invitation to connect to the vehicle system component to establish a private two-way communication channel for communication between the user device and a bot associated with the vehicle during a trip, wherein the invitation comprises information related to the initial information;
receiving an acceptance of the invitation;
responsive to receipt of the acceptance, creating the bot and establishing the private two-way communication channel between the user device and the bot;
sending, from the bot to the user, information responsive to received user information over the private two-way communication channel that incorporates the initial information; and
terminating the bot and the private two-way communication channel according to a termination criterion.

2. The method of claim 1, wherein the termination criterion is selected from the group consisting of a user indication of the trip conclusion, the user arriving at a pre-defined location, and completion of executing a pre-defined sequence of trip elements.

3. The method of claim 1, wherein the initial information is received prior to the trip.

4. The method of claim 1, wherein the initial information is received from the user device.

5. The method of claim 1, wherein the user device is a user aid that assists the user with an impairment.

6. The method of claim 5, wherein the user aid is a hearing aid comprising a telecoil used to communicate with the user.

7. The method of claim 1, wherein the user device comprises a microphone.

8. The method of claim 1, wherein the vehicle system component is a vehicle communication system incorporated into the vehicle, the method further comprising persistently storing the initial information.

9. The method of claim 8, wherein the initial information is stored in a user portion of a vehicle database, the method further comprising:
acquiring route information and persistently storing it in a route portion of the vehicle database;
acquiring vehicle information and persistently storing it in a vehicle portion of the vehicle database; and
sending information to the user device based on data from the user portion, the route portion, and the vehicle portion.

10. The method of claim 1, wherein the vehicle system component is a vehicle system server, the method further comprising persistently storing the initial information in a server database.

11. The method of claim 10, wherein the initial information is stored in a user portion of the server database, the method further comprising:
acquiring route information and persistently storing it in a route portion of the server database;
acquiring vehicle information and persistently storing it in a vehicle portion of the server database; and
sending information to the user device based on data from the user portion, the route portion, and the vehicle portion.

12. The method of claim 1, wherein the bot is provided as a service in a cloud environment.

13. The method of claim 1, further comprising persistently storing the initial information in the user device.

14. The method of claim 1, further comprising deleting the initial information from the vehicle system component upon the termination of the private two-way communication channel.

15. The method of claim 1, further comprising sending information to the user device based on information related to other users.

16. The method of claim 1, further comprising:
receiving an assistance request from the user;
sending the assistance request to other users requesting assistance for the user; and
sending a response to the sent assistance request to the user.

17. A vehicle system component comprising:
a processor that is configured to:
receive initial information related to a user of a vehicle;
send to a user device having a unique identifier, an invitation to connect to the vehicle system component to establish a private two-way communication channel for communication between the user device and a bot associated with the vehicle during a trip, wherein the invitation comprises information related to the initial information;
receive an acceptance of the invitation;
responsive to receipt of the acceptance, create the bot and establishing the private two-way communication channel between the user device and the bot;
send, from the bot to the user, information responsive to received user information over the private two-way communication channel that incorporates the initial information; and
terminate the bot and the private two-way communication channel according to a termination criterion.

18. The system component of claim 17, wherein the user device is a hearing aid that assists the user with a hearing loss, the hearing aid comprising a telecoil that is used to communicate with the user.

19. The system component of claim 17, wherein the vehicle system component is a vehicle communication system that is a part of the vehicle, the system component further comprising a vehicle database that is resident on the vehicle and persistently stores the initial information.

20. A computer program product for a vehicle system component, the computer program product comprising a computer readable storage medium having computer-readable program code embodied therewith to, when executed on a processor, causes the vehicle system component to:
receive initial information related to a user of a vehicle;
send to a user device having a unique identifier, an invitation to connect to the vehicle system component to establish a private two-way communication channel for communication between the user device and a bot associated with the vehicle during a trip, wherein the invitation comprises information related to the initial information;
receive an acceptance of the invitation;
responsive to receipt of the acceptance, create the bot and establishing the private two-way communication channel between the user device and the bot;
send, from the bot to the user, information responsive to received user information over the private two-way communication channel that incorporates the initial information; and
terminate the bot and the private two-way communication channel according to a termination criterion.
